(19) United States
(12) Patent Application Publication
(10) Pub. No.: US 2009/0254265 A1
(43) Pub. Date: Oct. 8, 2009

(54) VIDEO MAP TECHNOLOGY FOR NAVIGATION

(76) Inventors: Thimmannagari Chandra Reddy, Bangalore (IN); Muraleedhara Navada, Bangalore (IN); Narala Ravi, Bangalore (IN)

Correspondence Address: LOWE HAUPTMAN HAM & BERNER, LLP, 1700 DIAGONAL ROAD, SUITE 300, ALEXANDRIA, VA, 22314, US

(21) Appl. No.: 12/099,495

(22) Filed: Apr. 8, 2008

(51) Int. Cl. G01C 21/00; H04N 5/93

(52) U.S. Cl. 701/200; 386/52

(57) ABSTRACT

There remains a need for a navigation technology that is amenable for use in conditions prevalent in developing countries. The embodiments disclosed herein achieve this by providing a video map based navigation system and methods thereon. An embodiment herein provides an electronic navigation system comprising of a means for a user to request for a route between a source and a destination; a means to combine relevant stored video clips based on the source and the destination; a means for sending user requested information to the user; and a means for the user to view information sent by the navigation system.

### BACKGROUND

1. Technical Field

The embodiments herein generally relate to navigation, and, more particularly, to using video maps in navigation.

2. Description of the Related Art

Today we have multiple technologies which help in navigation. Existing technologies are largely Internet based and GPS. Internet based navigation systems utilize digital maps to provide turn-by-turn text directions from point A to point B. The navigation information can be printed out and used for navigation. On the other hand GPS based solutions typically provide a navigation device that uses GPS technology. GPS based devices use satellite data to find the latitude and longitude information and map the information onto a pre-loaded digital map to provide directions. Both these technologies may work fine in countries like USA and Canada but have severe limitations in developing countries.

Today digital maps information is not available for most of the developing countries and for the countries for which digital maps information is available, the information is not accurate enough to be able to use for navigation purposes. The other big concern is that many developing countries like India have narrow streets that have no names. Also, many a time, narrow streets are so very close to each other that in most cases the distance between one turn and other turn falls out of GPS tolerance range and usage of GPS in such circumstances may result erroneous navigation. In countries like India and other developing countries it is quite impossible to navigate using the existing navigation technologies.

Hence, there is a need for a technology that allows for navigation in circumstances existing in developing countries like India.

### SUMMARY

In view of the foregoing, an embodiment herein provides an electronic navigation system comprising of a means for a user to request for a route between a source and a destination; a means to combine relevant stored video clips based on the source and the destination; a means for sending user requested information to the user; and a means for the user to view information sent by the navigation system.

An embodiment further provides a method of electronic navigation utilizing a handheld device equipped with video player, video navigation software, stored video, the method comprising steps of a user requesting a route based on user preferences between a source and a destination; combining relevant video clips based on source and destination provided by the user; sending stored video clip to the user from the navigation system; and viewing of video clips by the user.

An embodiment also provides a method of capturing video of routes comprising of a video capture device, video editing software and storage device, the method comprising the steps of capturing video of roads along different routes; segmenting the captured video into smaller video clips; and storing the segmented video clips. These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 shows the software architecture to provide navigation map;

FIG. 2 shows remote device accessing a Web Server;

FIG. 3 shows video mapping elements;

FIG. 4 shows the screen of remote device;

FIG. 5 shows the route choices to the user;

FIG. 6 shows an embodiment where digital and video maps are provided by a GPS device;

FIG. 7 shows a flow diagram of the working of the GPS device; and

FIG. 8 shows the flow diagram when a user requests for navigation map using the internet.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

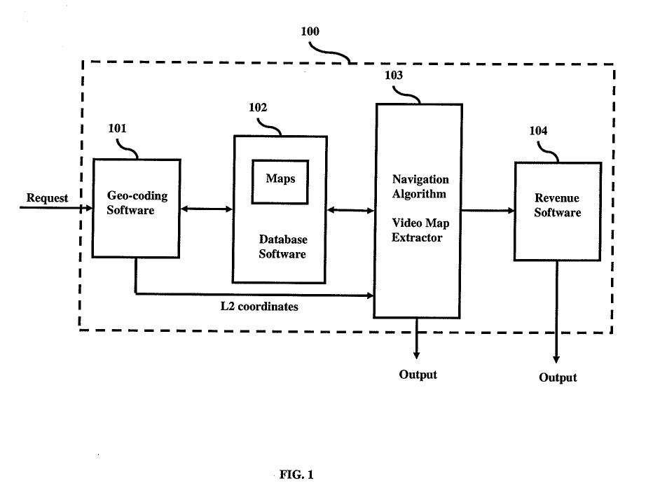

As mentioned, there remains a need for a navigation technology that is amenable for use in conditions like those prevalent in developing countries. The embodiments herein achieve this by providing a video map based navigation system and methods thereon. Referring now to the drawings, and more particularly to FIGS. 1 through 5, where similar reference characters denote corresponding features consistently throughout the figures, there are shown preferred embodiments.

FIG. 1 shows a software architecture (100) to provide navigation maps to a remote device. The user requests a navigation map using a remote device where said request is described herein. The Geo-coding software (101), e.g., C++ like Java interface, computes latitude and longitude coordinates herein referred to as ‘L2 coordinates’ which is used by a Database Software (102), e.g., Oracle, comprising of pre-stored maps or video elements to extract a requested map which a Video Map Extractor (103), e.g., C++ like Java interface, extracts the video map according to the navigation type requested by the remote device using navigation algorithm and L2 coordinates as described herein. Revenue software (104) calculates pricing of services provided according to service subscription of said remote device. In various embodiments the format of output includes HTML, map, MMS and/or SMS where the format of output depends on the request of remote device.

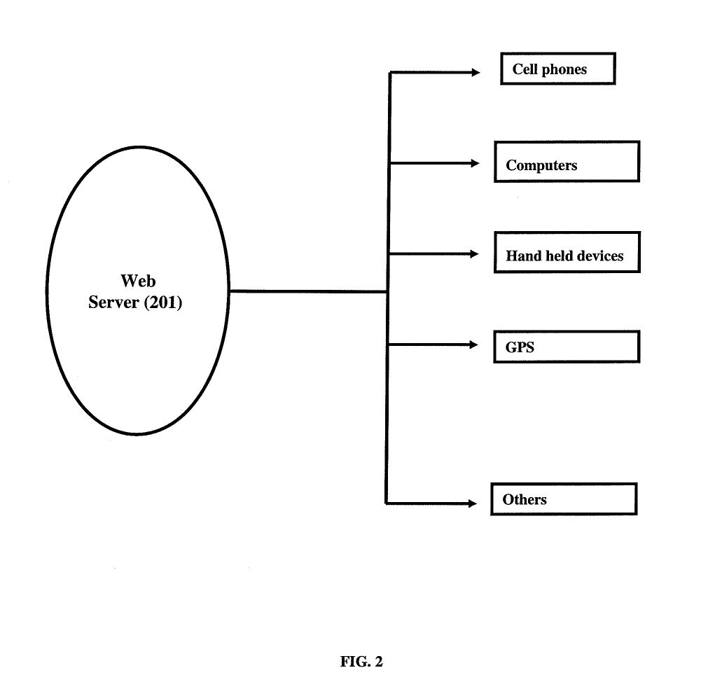

FIG. 2 shows said remote device accessing a web server (201), preferably the proprietary online web page of VidTeq, using standard accessibility methods. The remote device may include cell phones, computers, hand held devices, and/or GPS based devices. The system to provide video maps includes components for video recording which includes a video capture device, e.g., camcorder, attached to a vehicle where said map is a video clip of route between two points of interest. The video clip is captured by said video capture device when said vehicle is driven on the road and said captured video clip is uploaded into a web server or computer with large memory and hard drive. The video clip can be stored in compressed or uncompressed format.

In another embodiment, the capturing, editing and storing of said video clip in a hard drive as described herein can be automated. The system further comprises of video editing software, e.g., proprietary editing software owned by VidTeq, which edits video for features which includes quality and further adds information which includes text or audio format and/or music while storing said video in hard disk.

In another embodiment user can request for a video navigation map using said remote device by providing a source and destination address. Further, in other embodiments said user can provide L2 coordinates of the source and destination to request for a video navigation map.

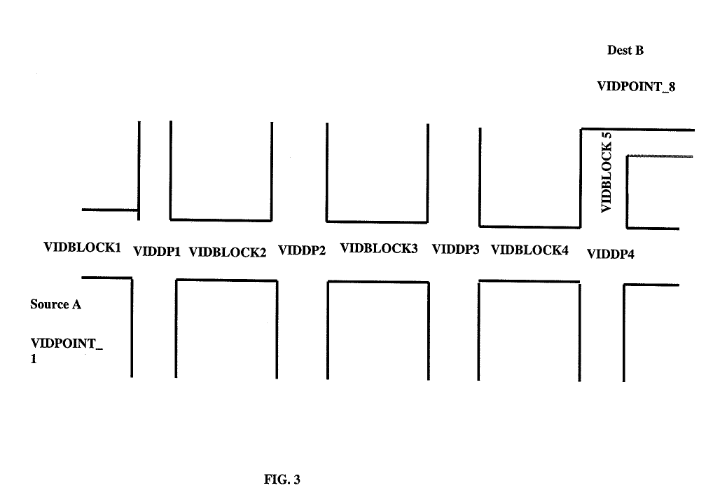

FIG. 3 shows the road with intersections and video mapping elements wherein VIDPOINT is a video clip or frame which includes video clips or frames of houses, apartments, buildings or landmarks. VIDDP denotes the video clip of the intersection point and VIDBLOCK is the video clip between any two VIDDPs'. VIDWAY is the navigation path sent to said remote device according to the request of said user as described herein.

The VID software in the server identifies video elements wherein elements comprise of said video elements which have to be stitched wherein the relevant VID elements are concatenated to form the navigation video map and provided to said requesting remote device.

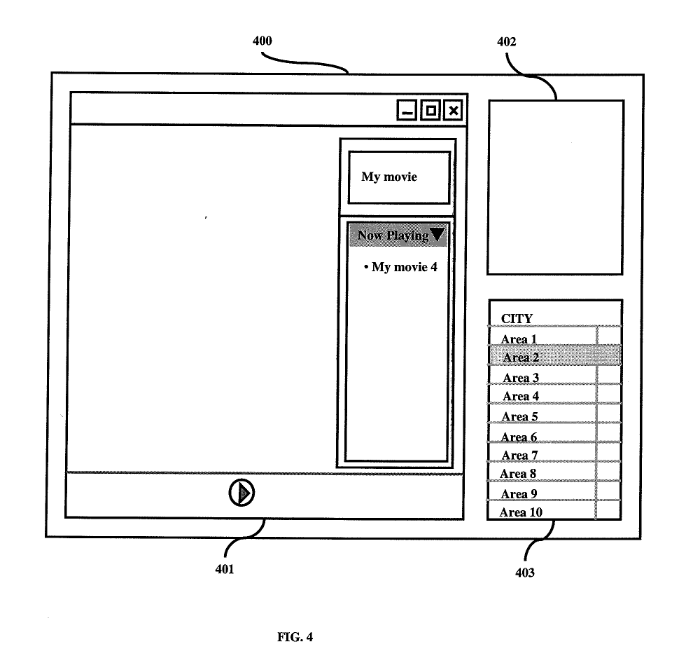

FIG. 4 illustrates a screen (400) of the remote device, e.g., computer, cell phone and PDA screens, wherein the video of the map is played in the video screen (401). Further in an embodiment Digital Map (VIDDAP) can be provided (402) on the screen (400). Further in another embodiment user of said remote device can see intermediate video clips by choosing any intermediate VID elements by using the VIDCLICK (403) option on screen (400).

The server, e.g., the proprietary server of VidTeq, can send the option selected by the user of said remote device to display on screen (400). The user can choose to play street video map wherein a selected street in the desired route is shown on said video screen (401) of said remote device. Further said user can choose to play a fast forward version of selected video map of desired route on said video screen (401). Further said user of remote device can choose to play the normal video map wherein selected video map is played at normal speed.

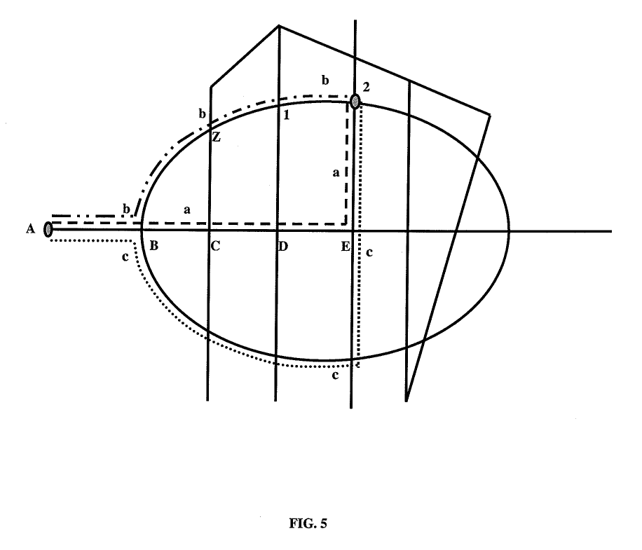

In various embodiments, said navigation algorithm (103) extracts the requested route according to the choice of the kind of route required by said user. FIG. 5 illustrates some of the possible choices of routes by said user where A is the source and 2 is the destination of the requested route. In an embodiment said user can choose the shortest route from source to destination and said algorithm can extract a navigation map as shown by the route represented by a in the figure. Further in an embodiment the user can choose a route wherein there are no by-lanes and/or narrow roads and the route represented by b is shown to said user of remote device. Further in an embodiment said user can choose a route with least traffic and navigation algorithm (103) extracts route represented by c in the figure.

In various embodiments the video map can be linked to GPS devices wherein said user can be provided with digital and video maps.

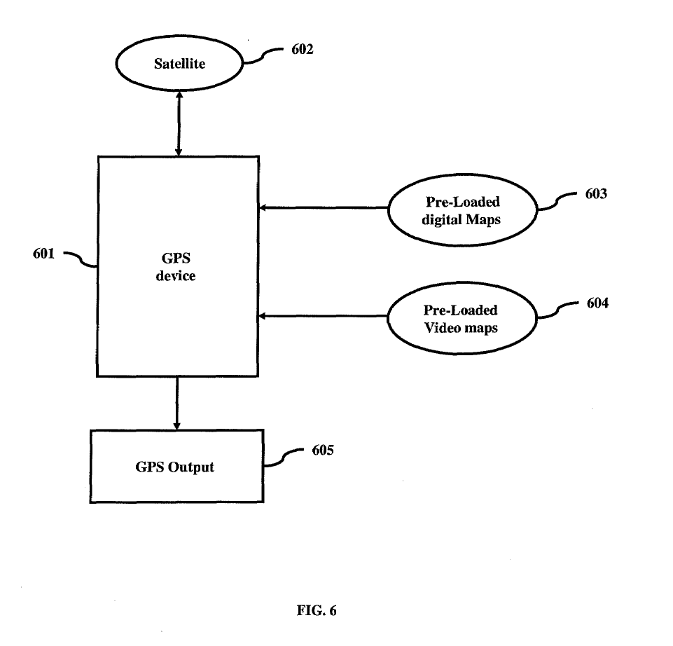

FIG. 6 shows an embodiment to provide digital and video maps to said user by a GPS device (601) comprising of a GPS chip which continuously samples navigation data from satellite (602). Said GPS device (601) comprises of pre-loaded digital maps (603) and pre-loaded video maps (604) which are loaded in the disk drive or memory of said device. Further, said pre-loaded video maps (604) comprise of video navigation software as described herein. GPS device (601) comprises of a GPS chip and the GPS output (605) comprises of digital and/or video map according to the request of said user.

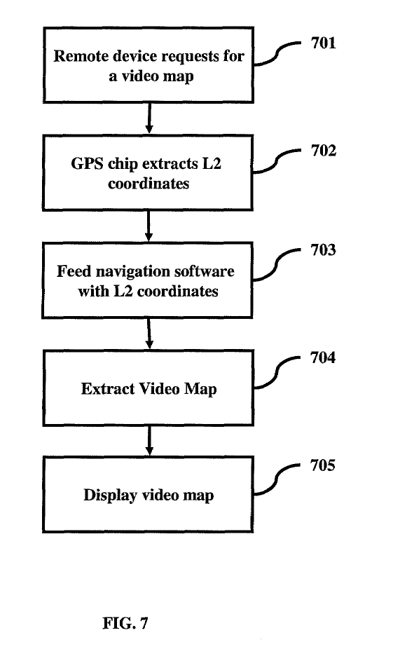

FIG. 7 shows the working of said GPS device (601) while providing a video map in response to a request (701) from said remote device. The GPS chip in said device computes L2 coordinates of requested source and destination (702) and feeds it to navigation software (703). Said navigation software extracts the relevant VID elements from memory comprising of pre-loaded video maps (704) and displays it to said remote device (705).

In an embodiment audio overlay of navigation details from the source to the destination is available to the user of said remote device from the GPS device providing video and digital maps.

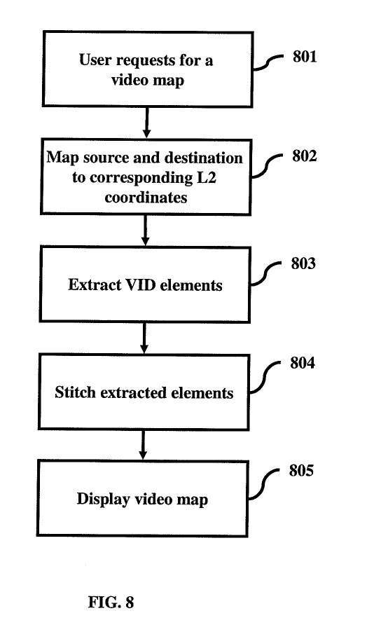

In an embodiment video clip service is offered to the user of web services as shown by the flow diagram of FIG. 8 wherein said user requests for a video map (801). The user can request using the internet, e.g., using the proprietary web page www.vidteq.com, wherein the video navigation software maps the source and destination addresses to corresponding L2 coordinates (802) wherein said coordinates are available from proprietary databases which includes the database of VidTeq. Further said software extracts VID elements relevant to said L2 coordinates (803) and said extracted VID elements are stitched (804) wherein the individual VID elements are stitched to form a Video Map and displayed on an output device (805), said remote device could be a remote computer, laptop or cell phone.

In an embodiment there is provided an option for a user to upload the video navigation map facility on a website wherein said user is referred to as ‘subscriber’ herein. Further, the subscriber can upload said map using means which includes internet, e.g., using the proprietary web page www.vidteq.com, wherein said map can be accessed by users who request for video maps from the subscriber. Further said user can request for the location of the subscriber by providing the source destination and store the video map in a storage device. The uploaded map is filtered according to the standard required which include quality by filters and the video maps are extracted as described herein.

In an embodiment said user may be directed to establishments in the requested route which includes major complexes, clubs and gathering spaces while accessing the digital maps.

In an embodiment the video map can be provided as a free service or for a nominal fee which is calculated by Revenue software (104).

In an embodiment various means to generate revenue by providing digital maps is disclosed wherein the provider, e.g., VidTeq, of said maps can adopt a model to generate revenue which includes a model to sell a part of the screen displaying the requested video maps to display advertisements. In another embodiment the provider of the digital map service to subscriber websites can collect a pre-determined amount as subscriber fees. Further, in another embodiment the provider of the digital map service can collect a pre-determined amount from establishments by directing said user to said establishments which subscribe to the service as described herein.

In various embodiments the video map can be pre loaded onto a storage device in GPS device or remote device. In an embodiment the user of said remote device can pause a video map and resume viewing said video map. In various embodiments the video clips can be refreshed in the database and combined to form the required video map hence providing updated maps to said user. In various embodiments the user can request for the video map using short messaging service (SMS) or Multimedia messaging service (MMS) wherein the user can request for video and/or digital map by sending an SMS or MMS from said remote device and receive the navigation directions which includes text directions, video map, and/or Digital Map.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A electronic navigation system comprising:
a) a means for a user to request a route between a source and a destination;
b) a means to combine relevant stored video clips based on said source and said destination;
c) a means for sending user requested information to said user; and
d) a means for user to view information sent by said navigation system.

2. The electronic navigation system of claim 1, wherein said user can request route between a source and a destination using a handheld device.

3. The electronic navigation system of claim 1, wherein said user can request route between a source and a destination using a GPS device.

4. The electronic navigation system of claim 1, wherein said user can request route between a source and a destination using a computer.

5. The electronic navigation system of claim 1, wherein said means to combine relevant stored video clips comprises of a video navigation software.

6. The electronic navigation system of claim 1, wherein said means for sending user requested information is through satellite communication.

7. The electronic navigation system of claim 1, wherein said means for sending user requested information is through line of sight communication.

8. The electronic navigation system of claim 1, wherein said means for sending user requested information is through the internet.

9. The electronic navigation system of claim 1, wherein said means for user to view information sent by said navigation system comprises of a video player in user device.

10. A method of electronic navigation comprising of a handheld device equipped with video player, video navigation software, stored video, said method comprising the steps of:
a) user requesting a route based on user preferences between a source and a destination;
b) combining relevant video clips based on source and destination provided by said user;
c) sending stored video clip to said user from said navigation system; and
d) said user viewing video clips.

11. The method of claim 10, wherein user preference is shortest route between said source and said destination.

12. The method of claim 10, wherein user preference is a route with no by lanes (gullies) between said source and said destination.

13. The method of claim 10, wherein user preference is fastest route between said source and said destination

14. The method of claim 10, wherein user requests for video clip by providing address of source and destination.

15. The method of claim 10, wherein user requests for video clip by providing latitude and longitude values of source and destination.

16. The method of claim 10, wherein combining relevant video clips based on source and destination provided by said user is done using video navigation software.

17. The method of claim 10, wherein the video clips can be viewed as a street video clip wherein the video shown is of a selected street.

18. The method of claim 10, wherein the video clips can be viewed in fast forward version of video clip between the source and destination.

19. The method of claim 10, wherein the video clips can be viewed in a non fast forward version of video between the source and destination is shown.

20. A method of capturing video of routes comprising of a video capture device, video editing software and storage device, said method comprising the steps of:
a) capturing video of roads along different routes;
b) segmenting said captured video into smaller video clips; and
c) storing said segmented video clips.
